(19) United States
(12) Patent Application Publication
(10) Pub. No.: US 2026/0286058 A1
(43) Pub. Date: Sep. 24, 2026

(54) Aerogel Intermediate And Method Of Producing The Same

(71) Applicant: Genesee Polymers Corporation, Burton, MI (US)

(72) Inventor: Charles R. Piskoti, Fenton, MI (US)

(73) Assignee: Genesee Polymers Corporation, Burton, MI (US)

(21) Appl. No.: 18/868,818

(22) PCT Filed: Jun. 1, 2023
(86) PCT No.: PCT/US2023/024151

§ 371 Date: Nov. 25, 2024

Related U.S. Application Data
(60) Provisional application No. 63/365,665, filed on Jun. 1, 2022.

(51) Int. Cl. C08G 77/18; C08J 9/00

(52) U.S. Cl. CPC C08G 77/18; C08J 9/00

(57) ABSTRACT

A method of producing an aerogel intermediate for subsequent conversion to an aerogel including providing a first source of silicon compound, with the silicon compound consisting essentially of dimethyl siloxane monomer units and providing a second source of silicon compound represented by Formula I, Formula II, or a combination thereof. The method further includes combining the first and second sources of silicon compound to form an aerogel precursor mixture and equilibrating the aerogel precursor mixture to form the aerogel intermediate. An aerogel intermediate formed from the method and for subsequent conversation to an aerogel is also provided.

### CROSS-REFERENCE TO RELATED APPLICATIONS

This application claims the benefit of and priority to U.S. Provisional Patent Application No. 63/365,665, filed Jun. 1, 2022, the disclosure of each of which is incorporated herein by reference in its entirety.

### BACKGROUND

Silicon-based aerogel production methods are known to include low amounts of dimethyl siloxane in the production process. In conventional aerogel production methods, the source of the dimethyl siloxane typically originates from dimethyldiethoxy silane (DMDES). The use of DMDES as a starting material is generally undesirable due to the expense of the material and underlining chlorine contamination, which has the potential to negatively impact pH sensitive aerogel production methods. Thus, there remains an opportunity to develop an alternative method of producing a silicon-based aerogel that includes an economically friendly source of dimethyl siloxane without underlining chlorine contamination.

### SUMMARY OF THE DISCLOSURE AND ADVANTAGES

In one aspect of the present disclosure a method of producing an aerogel intermediate for subsequent conversion to an aerogel is provided. The method includes providing a first source of silicon compound, with the silicon compound consisting essentially of dimethyl siloxane monomer units. The method also includes providing a second source of silicon compound represented by Formula I, Formula II, or a combination thereof;

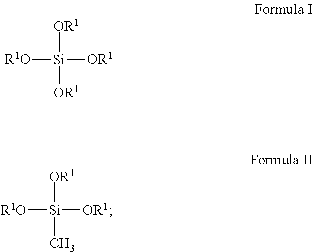

wherein R¹ is independently selected from methyl or ethyl. The method further includes combining the first and second sources of silicon compound to form an aerogel precursor mixture and equilibrating the aerogel precursor mixture to form the aerogel intermediate.

In another aspect of the present disclosure, another method of producing an aerogel intermediate for subsequent conversion to an aerogel is provided. The method includes providing a cyclic siloxane including 3-8 monomers units consisting of dimethyl siloxane as a first source of silicon compound. The method also includes providing a second silicon compound source represented by Formula Ia,

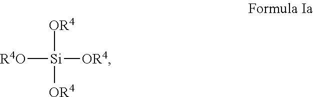

wherein R⁴ is ethyl. The method further includes combining the cyclic siloxane, the second source of silicon compound, and a basic catalyst to form an aerogel precursor mixture, with the aerogel precursor mixture consisting essentially of the cyclic siloxane, the silicon compound of Formula Ia, and the basic catalyst. The method further includes equilibrating the aerogel precursor mixture for 4 to 24 hours at a temperature of from 120 to 160° C. to form the aerogel intermediate. The aerogel intermediate of this aspect includes a combination of silicon compounds represented by Formula III, Formula IV, and Formula V,

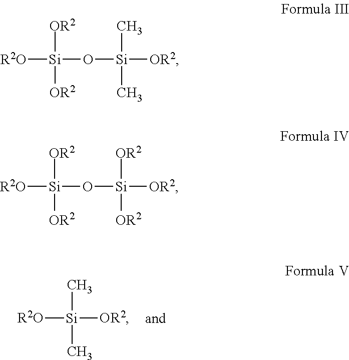

wherein R² is an ethyl group. The aerogel precursor mixture and the aerogel intermediate are substantially free of chlorine, and the aerogel intermediate is substantially free of the cyclic siloxane.

In another aspect of the present disclosure, an aerogel intermediate for subsequent conversion to an aerogel is provided. The aerogel intermediate includes a combination of silicon compounds including at least three silicon compounds represented by Formula IX-XIII and XV-XVII.

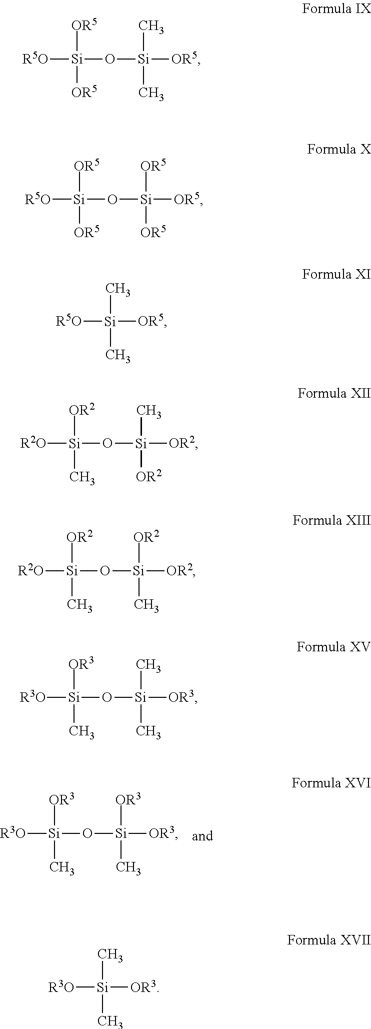

wherein R² and R⁵ is an ethyl group and R³ is a methyl group. The combination of silicon compounds is derived from equilibrating an aerogel precursor mixture. The aerogel precursor mixture includes the first source of silicon compound, with the silicon compound consisting essentially of dimethyl siloxane monomer units. The aerogel precursor mixture also includes the second source of silicon compound represented by Formula I, Formula II, or a combination thereof:

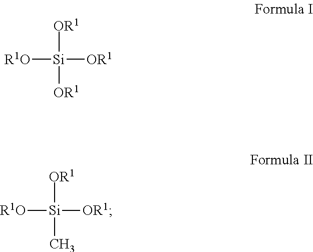

wherein R¹ is independently selected from methyl or ethyl. As a result of the equilibration step, the aerogel intermediate is essentially free of the first source of silicon compound.

### BRIEF DESCRIPTION OF THE DRAWINGS

Advantages of the present invention will be readily appreciated, as the same becomes better understood by reference to the following detailed description, when considered in connection with the accompanying drawings.

FIG. 1 is a chromatogram showing the separation of silicon compounds present in an aerogel intermediate according to the present disclosure.

### DETAILED DESCRIPTION OF THE DISCLOSURE

The present disclosure provides a method of producing an aerogel intermediate. The aerogel intermediate is a stable composition that is useful in a variety of methods of producing an aerogel. The method of producing the aerogel intermediate includes providing a first source of silicon compound, with the silicon compound consisting essentially of dimethyl siloxane monomer units. The method also includes a second source of silicon compound represented by Formula I, Formula II, or a combination thereof:

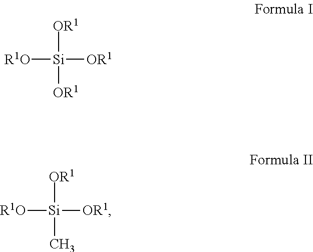

wherein R¹ is independently selected from methyl or ethyl. The method further includes combining the first and second sources of silicon compound to form an aerogel precursor mixture. Finally, the method includes equilibrating the aerogel precursor mixture to form the aerogel intermediate.

Referring first to the first source of silicon compound, the first source of silicon compound is typically either (1) a cyclic compound with each monomer unit in the cyclic compound being dimethyl siloxane or (2) polydimethyl siloxane (PDMS). Within the context of this disclosure, the phrase “consisting essentially of dimethyl siloxane monomer units” means that the first source of silicon compound includes less than 5 wt. % of monomeric units that are different than dimethyl siloxane provided that the units different than dimethyl siloxane do not negatively impact the dimethyl siloxane monomer units from rearranging during the equilibration step (described below).

When the first source of silicon compound is the cyclic siloxane, the monomer units forming the cyclic siloxane typically consists entirely of dimethyl siloxane. In other words, typically the cyclic siloxane only includes monomer units of dimethyl siloxane. The cyclic dimethyl siloxane may include from 3 to 10 monomer units of dimethyl siloxane. Alternatively, the cyclic dimethyl siloxane may include from 3 to 8, from 3 to 6, or from 4 to 6, monomer units.

When the first source of silicon compound is PDMS, the PDMS typically includes monomer units other than dimethyl siloxane. Most commonly, the monomers that are different than dimethyl siloxane are located at the terminal ends of the silicon compound. For example, the terminal ends or end caps may be derived from trimethylsilyl chloride. In most aspects, the only monomers included in the PDMS as the second silicon compound source that are different than dimethyl siloxane are the terminal monomers used to cap the silicon compound.

Although the first source of silicon compound may be a combination of cyclic dimethyl siloxane and PDMS, typically the first source of silicon compound consists of either cyclic dimethyl siloxane or PDMS.

The second source of silicon compound is a silane or combination of silanes represented by Formulas I and II. A specific example of Formula I includes tetraethyl orthosilicate, which may also be referred to as tetraethoxysilane or more simply TEOS. Another example of a silane represented by Formula I includes tetramethyl orthosilicate, which may also be referred to as tetramethoxysilane or more simply TMOS. A specific example of Formula II includes triethoxylmethyl silane, which may also be referred to as methyltriethoxy silane or more simply MTES. Another example of a silane represented by Formula II includes trimethoxymethyl orthosilicate, which may also be referred to as methyltrimethoxysilane or more simply MTMS. The second source of silicon compound may include a combination of two or more of TEOS, TMOS, MTES, or MTMS. The second source of silicon compound may also include only one of TEOS, TMOS, MTES, or MTMS. For example, in certain aspects the second source of silicon compound consists of TEOS. Alternatively, the second source of silicon compound consists of TMOS. Alternatively, the second source of silicon compound consists of MTES. Alternatively, the second source of silicon compound consists of MTMS.

The first and second sources of silicon compound are combined to form an aerogel precursor mixture. Typically, the number of moles of the silicon compound of the second source is greater than the number of moles of the silicon compound from the first source. In certain aspects, the silicon compound from the first source may be included in an amount of from 10 to 50 mol. % and the silicon compound from the second source may be included in an amount of from 50 to 90 mol. %, based on the total moles of silicon compound from the first and second sources. Alternatively, the silicon compound from the first source may be included in an amount of from 20 to 40 mol. % and the silicon compound from the second source may be included in an amount of from 60 to 80 mol. %, based on the total moles of silicon compound from the first and second sources. In one aspect, the aerogel precursor mixture includes 30 mol. % of cyclic dimethyl siloxane and 70 mol. % of TEOS.

The aerogel precursor mixture may include an acid or base catalyst in addition to the first and second sources of silicon compound. Typically, the aerogel precursor mixture includes only the catalyst and the first and second sources of silicon compound. When a basic catalyst is selected, typically an alkali metal hydroxide, such as potassium hydroxide is used. Although not required, typically the aerogel precursor mixture is substantially free of chlorine. With the context of this disclosure, the phrase “substantially free of chlorine” means that the aerogel precursor mixture includes less than 0.5 wt. % of chlorine based on the total weight of the aerogel precursor mixture. Alternatively, the aerogel precursor mixture may include less than 0.1 wt. % of chlorine based on the total weight of the aerogel precursor mixture. In one aspect, the aerogel precursor mixture includes less than 0.01 wt. % of chlorine. Because the aerogel precursor mixture is substantially free of chlorine, the aerogel intermediate is also substantially free of chlorine. Arriving at the aerogel intermediate that is substantially free of chlorine is beneficial as production methods of forming an aerogel are often pH sensitive and the presence of chlorine may interfere with the aerogel formation or reduce consistency across multiple batches.

As described above, the method also includes equilibrating the aerogel precursor mixture to form the aerogel intermediate. During the equilibration step of the method, the aerogel precursor mixture may be heated to and held at a temperature of 120 to 160° C. The length of the equilibration step is typically between 4 and 24 hours. In practice, the length of the equilibration step is set to obtain the desired conversion of the first source of silicon compound (described further below). Those skilled in the art will understand that analytical testing (e.g., gas chromatography) can be used to determine the degree of conversion and thus the appropriate length of the equilibration step for a specific temperature.

Although not required, the aerogel intermediate may include up to 50 wt. % of Formula I and/or Formula II, based on the total weight of the aerogel intermediate. Generally, the amount of Formula I and Formula II present in the aerogel intermediate is determined by the degree of stoichiometric excess of the second source of silicon compound combined with the first source of silicon compound in the aerogel precursor mixture. Controlling the stoichiometry in this manner is intended to prevent the formation of high order reaction products from forming during the equilibration step.

Without being held to any particular theory, it is believed that that during the equilibration step, the individual dimethyl siloxane monomer units of the cyclic siloxane and/or PDMS will react with the alkoxy functionality present in Formula I and/or Formula II to establish a relatively more energetically favorable arrangement. As described above, typically a relatively greater mol. % of silicon compound from the second source is present in the aerogel precursor mixture as compared to the mol. % of silicon compound from the first source. This stoichiometric balance generally results in near or complete conversion of the silicon compound present in the first source. In other words, after the equilibration step, the aerogel intermediate is essentially free of the first source of silicon compound because the monomers making up the cyclic siloxane and/or PDMS have separated from each other and reacted with the alkoxy functionality on the silicon compound of the second source (i.e., Formulas I and II). With the context of this disclosure, the phrase “essentially free of the first source of silicon compound” means that less than 3 wt. % of the silicon compound(s) in the first source remains unreacted and present in the aerogel intermediate. Often, when the equilibration step is conducted with the basic catalyst and a temperature of 120 to 160° C., less than 1 mol. % of the silicon compound in the first source is present in the aerogel intermediate. However, as a further result of the stoichiometric excess of Formula I and/or Formula II, the aerogel intermediate generally includes a significant amount of Formula I and/or II. Said differently, because a molar excess of Formula I and/or Formula II is included in the aerogel precursory mixture, a significant portion of Formula I and/or Formula II does not react with the dimethyl siloxane monomer units during the equilibration step. Although not required, the aerogel intermediate may include from 0 to 60 wt. % of Formula I and/or Formula II, based on the total weight of the aerogel intermediate. Alternatively, the aerogel intermediate may include from 10 to 50 wt. % or from 15 to 45 wt. %, of Formula I and/or Formula II, based on the total weight of the aerogel intermediate.

The reaction products resulting from the equilibration step may include silicon compounds represented by Formulas IX, X, and XI:

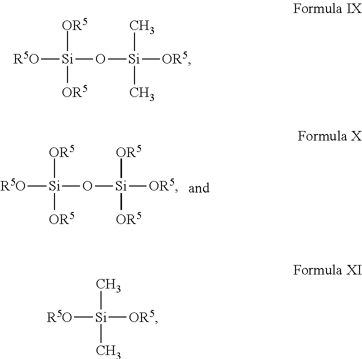

wherein R⁵ is a methyl or ethyl group.

More specifically, the reaction product resulting from the equilibration step include silicon compounds represented by Formula III, Formula IV, and Formula V when the second source of silicon compound includes TEOS:

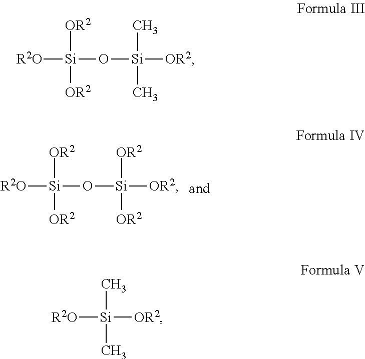

wherein R² is an ethyl group.

The reaction product resulting from the equilibration step include silicon compounds represented by Formula VI, Formula VII, and Formula VIII, when the second source of silicon compound includes TMOS:

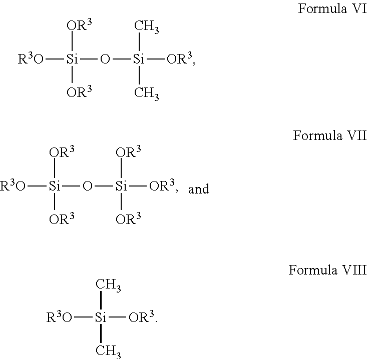

wherein R³ is a methyl group.

Alternative reaction product resulting from the equilibration step include silicon compounds represented by Formula XII, Formula XIII, and Formula XIV, when the second source of silicon compound includes MTES:

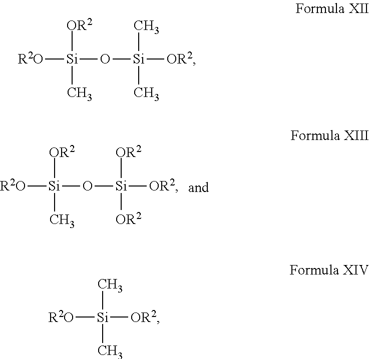

wherein R² is an ethyl group.

The reaction product resulting from the equilibration step include silicon compounds represented by Formula XV, Formula XVI, and Formula XVII, when the second source of silicon compound includes MTMS:

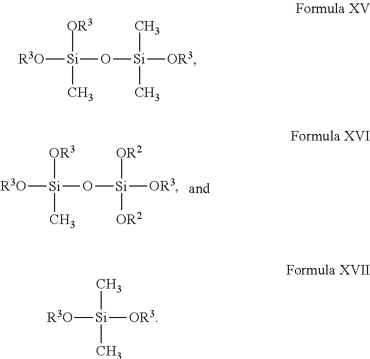

wherein R³ is a methyl group.

As described above, TEOS, TMOS, MTES, MTMS, and a combination thereof may be used as the second source of silicon compound. When a combination of two or more of the above referenced silanes are used as the second source, the aerogel intermediate will include the combination of reaction products for each silicon compound in the second source. For example, if both TEOS and TMOS are used as the second source of silicon compound, the aerogel intermediate will include reaction products represented by Formulas III-VIII.

The present disclosure also provides a method for forming an aerogel with the aerogel intermediate. The method includes combining the aerogel intermediate described above with a third source of silicon compound to form a second aerogel precursor mixture. The method may also include combining water and a basic or acidic catalyst with the second aerogel precursor mixture. The method further includes condensing and hydrolyzing the second aerogel precursor mixture to form the aerogel. The silicon compound of the third source is not particularly limited and may include silicon compound that are the same as or different than the silicon compound of the second source. However, the second source of silicon compound is often selected to include silicon compounds that will be present in the third source. The method of forming the aerogel may also include an extraction step to remove undesirable byproducts resulting from the condensation and hydrolysis reactions of the second aerogel precursor. Typically, the extraction is done with a supercritical fluid.

### EXAMPLES

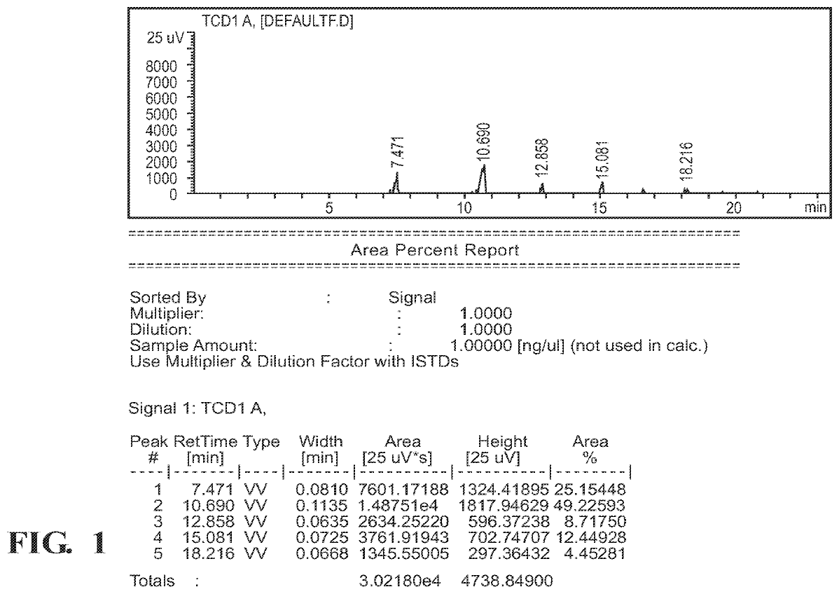

An aerogel precursor mixture was formed by combining 30 mol. % of cyclic dimethyl siloxane as a first source of silicon compound with 70 mol. % of TEOS as a second source of silicon compound. Potassium hydroxide (i.e., an alkali metal hydroxide catalyst) was also included in the aerogel precursor mixture. The aerogel precursor mixture was equilibrated by heating and holding the precursor mixture to a temperature of 120 to 160° C. for approximately 12 hours to form the aerogel intermediate. The alkali metal hydroxide catalyst was removed from the aerogel intermediate using standard laboratory techniques. A sample was prepared from the aerogel intermediate and analyzed with gas chromatography. The results from the analysis are provided in FIG. 1. The analysis indicates that the 30 mol % of the cyclic dimethyl siloxane used to form the aerogel precursor mixture was consumed during the equilibration step such that the aerogel intermediate is essentially free of the cyclic dimethyl siloxane. The analysis as indicated that the 70 mol % of TEOS included in the aerogel precursor mixture was significantly reduced due to the fact that the aerogel intermediate includes only 40 wt. % of TEOS (retention time of 10.7 minutes) based on the total weight of the aerogel intermediate. The analysis also detected approximately 20 wt. % of dimethyldiethoxy silane (Formula V; retention time of 7.4 minutes) as being present in the aerogel intermediate. Notably, dimethyldiethoxy silane was not present in the aerogel precursor mixture and was thus formed during the equilibration step. The analysis also indicates the presence of additional reaction products formed during the equilibration step, which likely include the silicon compounds represented by Formulas III and IV.

It is to be understood that the appended claims are not limited to express any particular compounds, compositions, or methods described in the detailed description, which may vary between particular embodiments which fall within the scope of the appended claims. With respect to any Markush groups relied upon herein for describing particular features or aspects of various embodiments, different, special, and/or unexpected results may be obtained from each member of the respective Markush group independent from all other Markush members. Each member of a Markush group may be relied upon individually and or in combination and provides adequate support for specific embodiments within the scope of the appended claims.

Further, any ranges and subranges relied upon in describing various embodiments of the present disclosure independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present disclosure, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The present disclosure has been described in an illustrative manner, and it is to be understood that the terminology which has been used is intended to be in the nature of words of description rather than of limitation. Many modifications and variations of the present disclosure are possible in light of the above teachings. The present disclosure may be practiced otherwise than as specifically described. The subject matter of all combinations of independent and dependent claims, both singly and multiply dependent, is herein expressly contemplated.

1. A method of producing an aerogel intermediate for subsequent conversion to an aerogel, the method comprising:
providing a first source of silicon compound, with the silicon compound consisting essentially of dimethyl siloxane monomer units;
providing a second source of silicon compound represented by Formula I, Formula II, or a combination thereof; 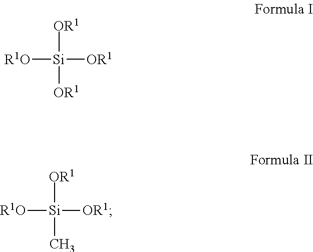
wherein R¹ is independently selected from methyl or ethyl;
combining the first and second sources of silicon compound to form an aerogel precursor mixture; and
equilibrating the aerogel precursor mixture to form the aerogel intermediate.

2. The method as set forth in claim 1 wherein the aerogel intermediate is essentially free of the first source of silicon compound.

3. The method as set forth in claim 2 wherein the aerogel intermediate includes less than 50 wt. % of Formula I and Formula II based on the total weight of the aerogel intermediate.

4. The method as set forth in claim 3 wherein the aerogel intermediate includes a plurality of reaction products derived from a reaction between (1) the individual monomer units originating from the first source of silicon compound and (2) the alkoxy functionality in Formula I, Formula II, or a combination thereof.

5. The method as set forth in claim 1 wherein the first source of silicon compound consists of a cyclic siloxane.

6. The method as set forth in claim 5 wherein the cyclic siloxane includes 4 to 6 monomer units of dimethyl siloxane.

7. The method as set forth in claim 1 wherein the first source of silicon compound consists of polydimethyl siloxane.

8. The method as set forth in claim 1 wherein the aerogel precursor mixture consists of the first and second sources of silicon compound and a basic catalyst.

9. The method as set forth in claim 8 wherein the basic catalyst is an alkali metal hydroxide.

10. The method as set forth in claim 9 wherein R¹ is an ethyl group.

11. The method as set forth in claim 1 wherein the second source of silicon compound includes only Formula I with R¹ being an ethyl group.

12. The method as set forth in claim 1 wherein the aerogel intermediate includes silicon compounds represented by Formula III, Formula IV, and Formula V, 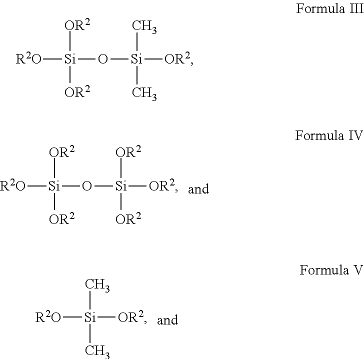
wherein R² is an ethyl group.

13. The method as set forth in claim 1 wherein R¹ is methyl.

14. The method as set forth in claim 13 wherein the second source of silicon compound includes only Formula I with R¹ being a methyl group.

15. The method as set forth in claim 13 wherein the second source of silicon compound includes Formula I with R¹ being a methyl group and wherein there the aerogel intermediate includes silicon compounds represented by Formula VI, Formula VII, and Formula VIII, 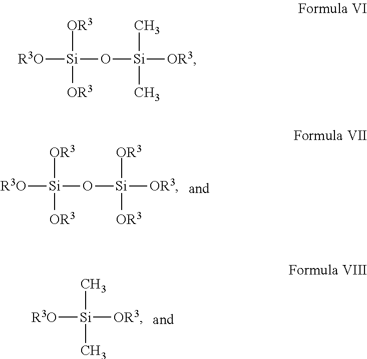
wherein R³ is a methyl group.

16. The method as set forth in claim 1 wherein the aerogel precursor mixture is equilibrated for a time of from 4 to 24 hours at a temperature of from 120 to 160° C.

17. The method as set forth in claim 1 wherein the aerogel precursor mixture and the aerogel intermediate are substantially free of chlorine.

18. A method of forming an aerogel, the method comprising
combining the aerogel intermediate as set forth in claim 1 and a third silicon compound source to form a second aerogel precursor mixture, and
condensing and hydrolyzing the second aerogel precursor mixture to form the aerogel.

19. A method of producing an aerogel intermediate for subsequent conversion to an aerogel, the method comprising:
providing a cyclic siloxane including 3-8 monomers units consisting of dimethyl siloxane;
providing a second silicon compound source represented by Formula Ia, 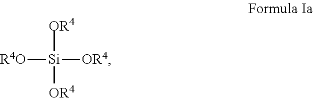
wherein R⁴ is ethyl;
combining the cyclic siloxane, the second source of silicon compound, and a basic catalyst to form an aerogel precursor mixture, with the aerogel precursor mixture consisting essentially of the cyclic siloxane, the silicon compound of Formula Ia, and the basic catalyst; and
equilibrating the aerogel precursor mixture for 4 to 24 hours at a temperature of from 120 to 160° C. to form the aerogel intermediate;
wherein the aerogel intermediate includes a combination of silicon compounds represented by Formula III, Formula IV, and Formula V, 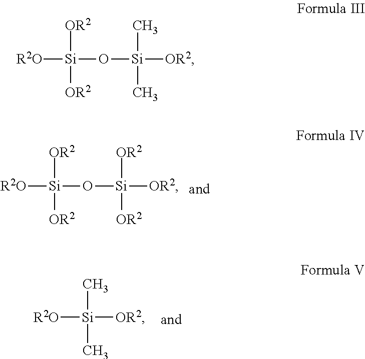
wherein R2 is an ethyl group; and
wherein the aerogel precursor mixture and the aerogel intermediate are substantially free of chlorine, and the aerogel intermediate is substantially free of the cyclic siloxane.

20. An aerogel intermediate for subsequent conversion to an aerogel comprising:
a combination of silicon compounds including at least three silicon compounds represented by Formula IX-XIII and XV-XVII: 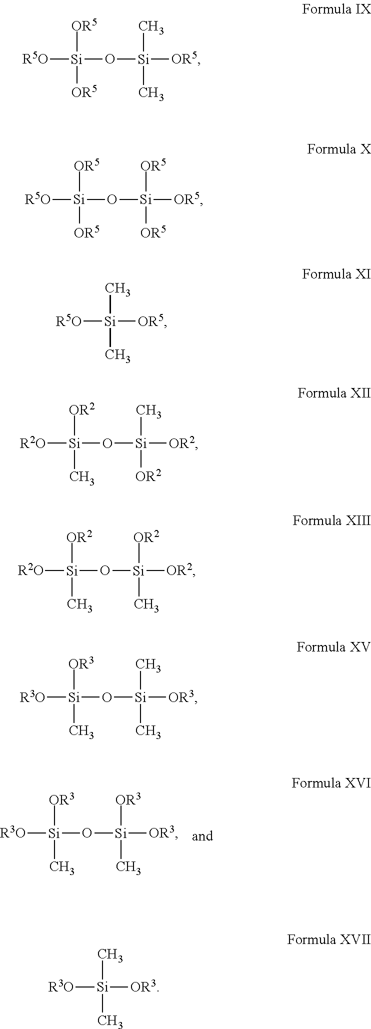
wherein R² and R⁵ is an ethyl group and R³ is a methyl group;
wherein the combination of silicon compounds is derived from equilibrating an aerogel precursor mixture comprising;
a first source of silicon compound, with the silicon compound consisting essentially of dimethyl siloxane monomer units; and
a second source of silicon compound represented by Formula I, Formula II, or a combination thereof; 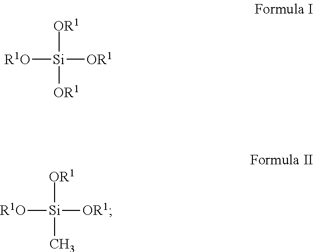
wherein R¹ is independently selected from methyl or ethyl; and
wherein the aerogel intermediate is essentially free of the first source of silicon compound.
